(19) United States
(12) Patent Application Publication
(10) Pub. No.: US 2009/0253910 A1
(43) Pub. Date: Oct. 8, 2009

(54) Phosphorescent Materials

(76) Inventors: Bin Ma, West Windsor, NJ (US); Raymond Kwong, Plainsboro, NJ (US); Peter B. MacKenzie, Kingsport, TN (US); Elaine MacKenzie, Kingsport, TN (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/098,659

(22) Filed: Apr. 7, 2008

(51) Int. Cl. C07F 15/00

(52) U.S. Cl. 546/4

(57) ABSTRACT

Phosphorescent organometallic materials are provided, comprising at least one 3-arylacetylacetone ligand. Processes for making such materials, and to organic light emitting devices comprising the materials, are also provided.

### FIELD OF THE INVENTION

The present invention is directed to phosphorescent materials that are color tunable, and that provide high device efficiency and stability.

### BACKGROUND OF THE INVENTION

Organometallic iridium phosphorescent materials are known. Examples of organometallic iridium phosphorescent materials are disclosed in U.S. Pat. No. 6,835,469, U.S. Provisional Patent Application No. 60/682,690, Am. Chem. Soc., 2001, 123, 4304, U.S. Patent Application Publication No. US 2001/0019782, now U.S. Pat. No. 6,821,645, and U.S. Patent Application Publication No. 2005/0164030, the contents of which are incorporated herein in their entirety by reference.

Phosphorescent materials are also disclosed in U.S. Provisional Patent Applications No. 60/732,893, filed Nov. 1, 2005, and 60/761,567, filed on Jan. 23, 2006, and U.S. Pat. No. 6,951,694, ORGANIC LIGHT EMITTING DEVICES WITH ELECTRON BLOCKING LAYERS, U.S. Pat. No. 6,939,624, ORGANOMETALLIC COMPOUNDS AND EMISSION-SHIFTING ORGANIC ELECTROPHOSPHORESCENCE, U.S. Pat. No. 6,916,554, ORGANIC LIGHT EMITTING MATERIALS AND DEVICES, U.S. Pat. No. 6,911,271, ORGANOMETALLIC PLATINUM COMPLEXES FOR PHOSPHORESCENCE BASED ORGANIC LIGHT EMITTING DEVICES, U.S. Pat. No. 6,902,833, MATERIALS AND STRUCTURES FOR ENHANCING THE PERFORMANCE OR ORGANIC LIGHT EMITTING DEVICES, U.S. Pat. No. 6,902,830, ORGANOMETALLIC COMPLEXES AS PHOSPHORESCENT EMITTERS IN ORGANIC LEDS, U.S. Pat. No. 6,894,307, INTERSYSTEM CROSSING AGENTS FOR EFFICIENT UTILIZATION OF EXCITONS IN ORGANIC LIGHT EMITTING DEVICES, U.S. Pat. No. 6,885,025, ORGANIC LIGHT EMITTING DEVICE STRUCTURES FOR OBTAINING CHROMATICITY STABILITY, U.S. Pat. No. 6,872,477, OLEDS DOPED WITH PHOSPHORESCENT COMPOUNDS, U.S. Pat. No. 6,869,695, WHITE LIGHT EMITTING OLEDS FROM COMBINED MONOMER AND AGGREGATE EMISSION, U.S. Pat. No. 6,835,469 PHOSPHORESCENT COMPOUNDS AND DEVICES COMPRISING THE SAME, and U.S. Pat. No. 6,830,828, ORGANOMETALLIC COMPLEXES AS PHOSPHORESCENT EMITTERS IN ORGANIC LEDS, the contents of which are incorporated herein in their entirety by reference.

### SUMMARY OF THE INVENTION

The present invention is directed to phosphorescent organometallic materials, comprising at least one 3-arylacetylacetone ligand, to processes for making such materials, and to organic light emitting devices comprising the materials of the invention. Preferred materials in accordance with the invention include compounds of the formula (I):

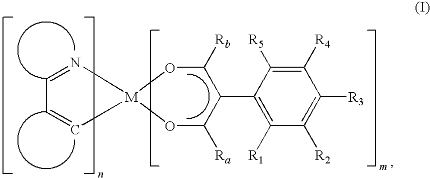

where M is a heavy metal, having an atomic weight greater than 40, Rₐ, R_{b}, and R₁ to R₅ are independently H, alkyl, alkenyl, alkynyl, aryl, arylalkyl, heteroaryl and heteroarylalkyl, and M is preferably iridium(III) and platinum(II). Compounds of the invention include, but are not limited to,

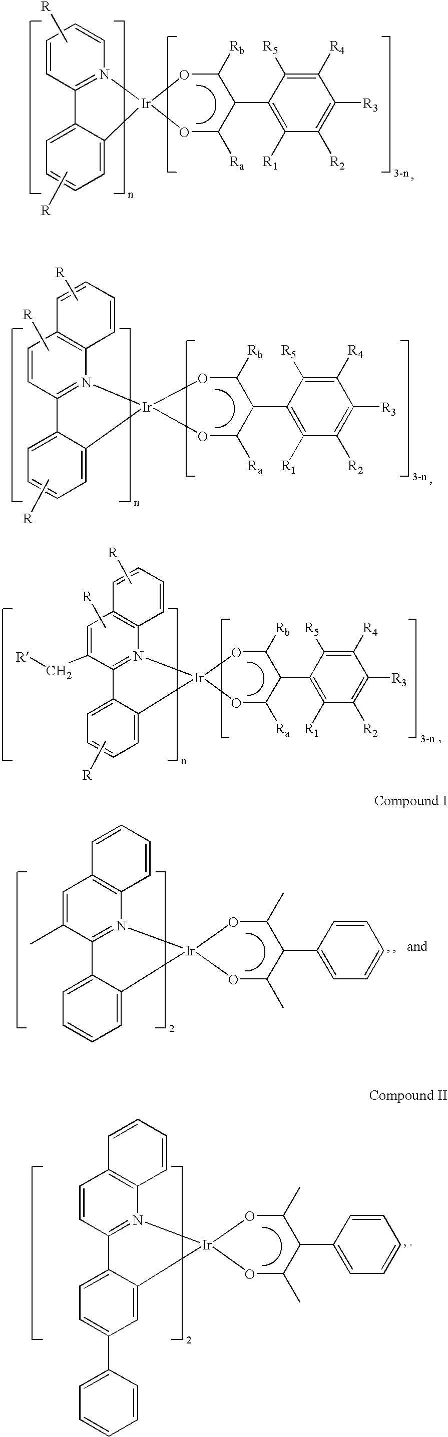

### BRIEF DESCRIPTION OF THE DRAWINGS

FIG. 1 illustrates an EL spectra of Device Examples 1 to 4 at a current density of 10 mA/cm²;

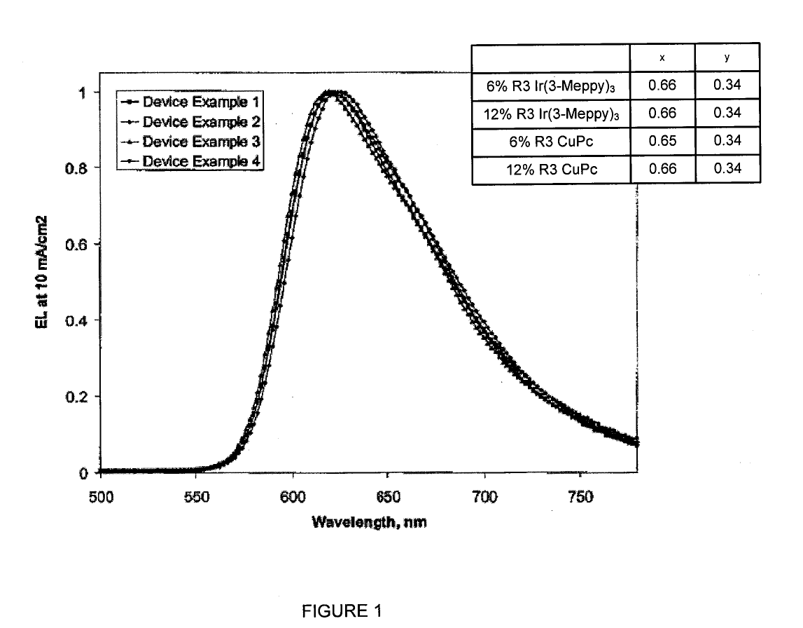

FIG. 2 illustrates the current density vs. voltage of Device Examples 1 to 4;

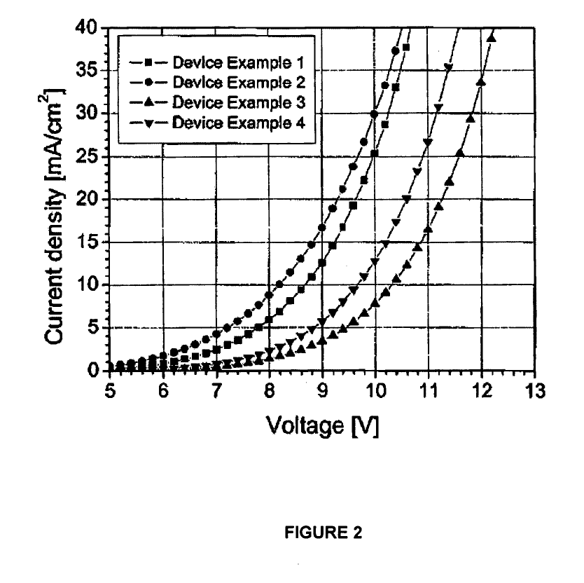

FIG. 3 illustrates the luminous efficiency vs. luminance of Device Examples 1 to 4;

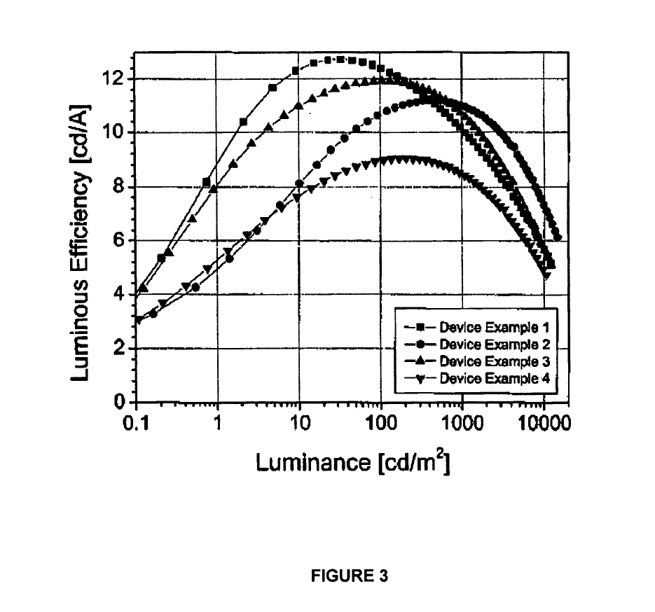

FIG. 4 illustrates the external quantum efficiency vs. luminance of Device Examples 1 to 4;

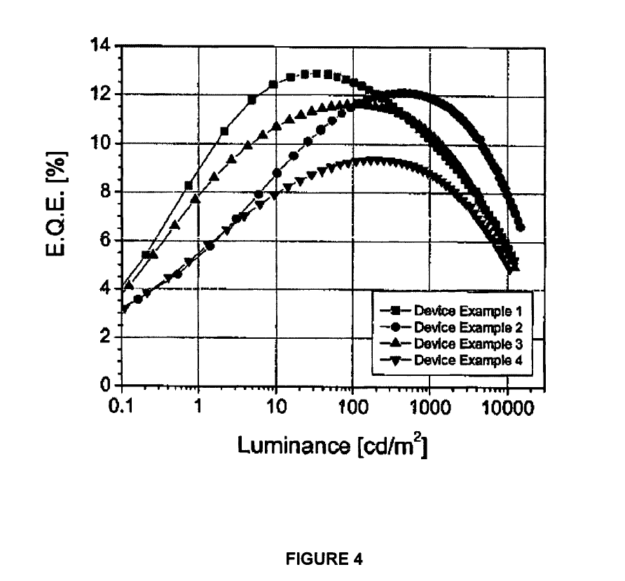

FIG. 5 illustrates the operation stability of Device Examples 1 to 4 and Comparative Device Example 3 under a constant DC of 40 mA/cm² at room temperature;

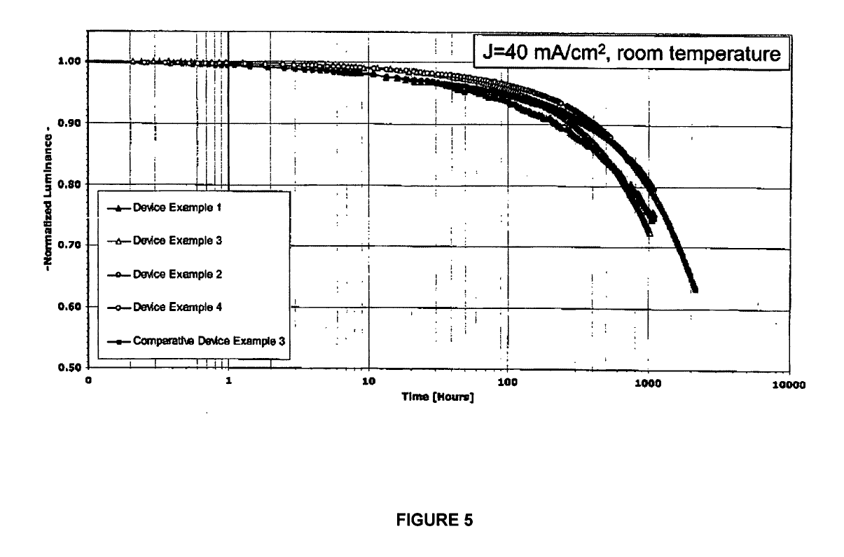

FIG. 6 illustrates the EL spectra of Device Examples 5 to 8 at a current density of 10 mA/cm²;

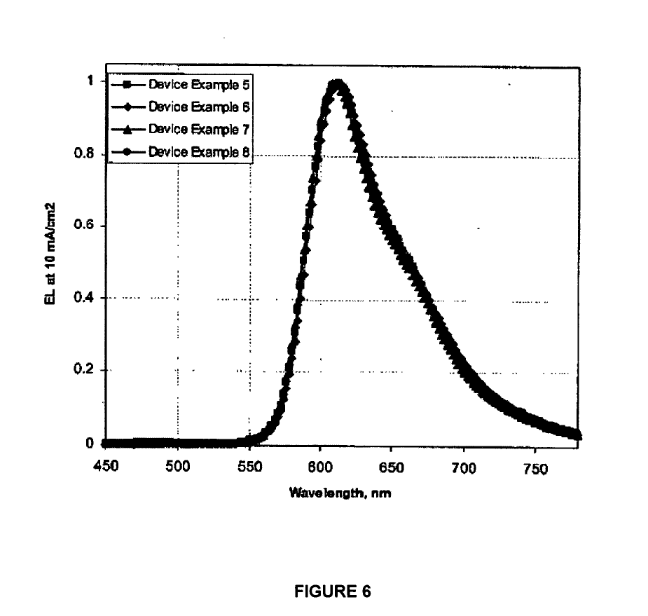

FIG. 7 illustrates the current density vs. voltage of Device Examples 5 to 8;

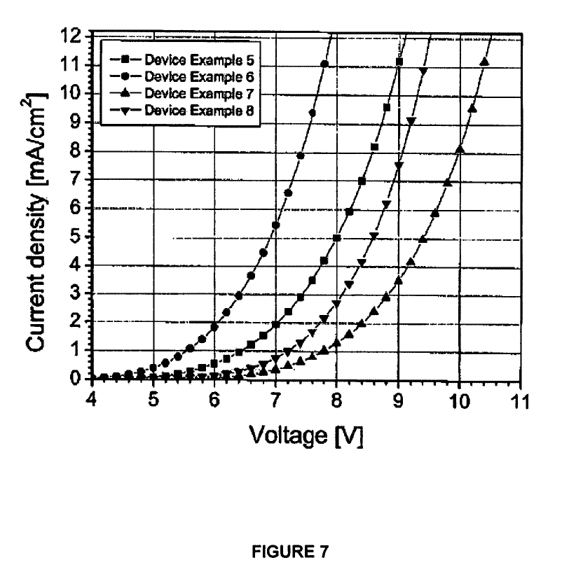

FIG. 8 illustrates the luminous efficiency vs. luminance of Device Examples 5 to 8;

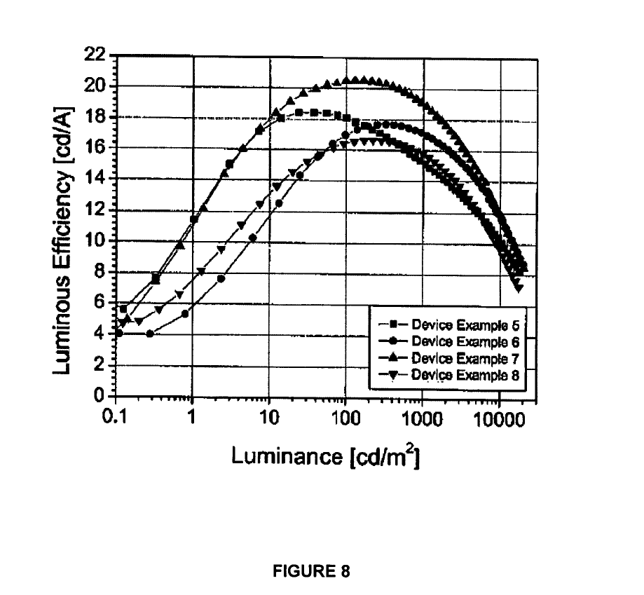

FIG. 9 illustrates the external quantum efficiency vs. luminance of Device Examples 5 to 8;

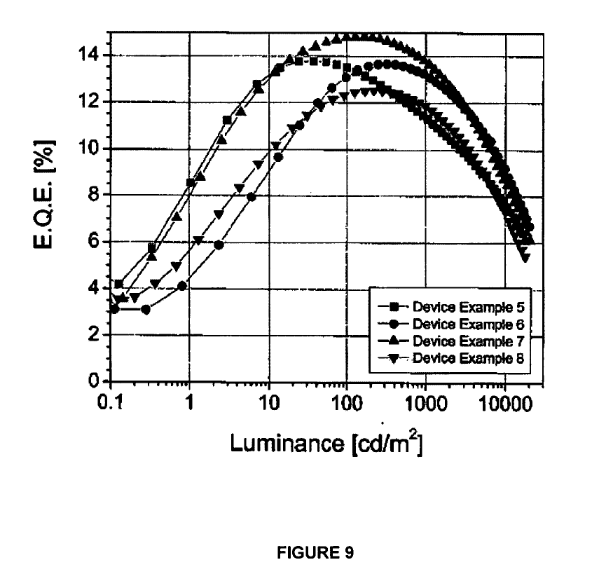

FIG. 10 illustrates the operation stability of Device Examples 5 to 8 under a constant DC of 40 mA/cm² at room temperature.

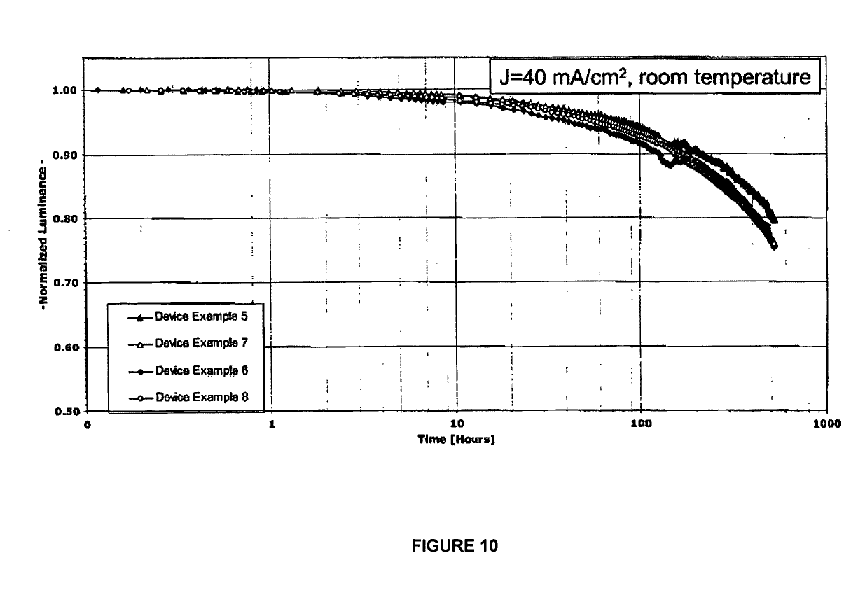

### DETAILED DESCRIPTION

Organometallic iridium phosphorescent materials in accordance with the invention have been synthesized, and OLEDs incorporating the phosphorescent materials of the invention as the dopant emitters have been fabricated by vacuum thermal evaporation. The devices have high EL efficiency and high stability. The device data based on device structure R₃ are summarized in Table 1 below.

The devices structures are abbreviated as: R3: HIL(100 Å)/NPD(300 Å)/BAlq:Dopant (300 Å, x %)/Alq₃(550 Å)/LiF(10 Å)/Al(1000 Å). For comparison, devices comprising Ir(3-Mepq)₂(acac),

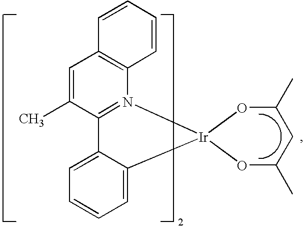

were also prepared.

### Experimental:

### Device Fabrication and Measurement

All devices were fabricated by high vacuum (<10⁻⁷ Torr) thermal evaporation. The anode electrode of each device was about 1200 Å of indium tin oxide (ITO), and the cathode was about 10 Å of LiF, followed by 1,000 Å of Al. All devices were encapsulated with a glass lid, sealed with an epoxy resin in a nitrogen glove box (<1 ppm of H₂O and O₂) immediately after fabrication. A moisture getter was incorporated inside the package. The organic stack from the ITO surface was sequentially as follows: 100 Å thick of copper phthalocyanine (CuPc), or iridium tris(3-methyl-2-phenylpyridine) [Ir(3-Meppy)₃], as the hole injection layer (HIL), 300 Å of 4,4′-bis[N-(1-naphthyl)-N-phenylamino]biphenyl (α-NPD), as the hole transporting layer (HTL), 300 Å of bis(2-methyl-8-hydroxyquinoline)aliuminum 4-phenylphenolate (BAlq) doped with 6 or 12 weight percent of the dopant emitter, i.e., the compounds of the invention and comparative compounds, as the emissive layer (EML), 550 Å of tris(8-hydroxyquinolinato)aluminum (Alq₃) as the ETL1. This structure is abbreviated as the R3 structure: HIL(100 Å)/NPD(300 Å)/BAlq:Dopant(300 Å, x %)/Alq3(550 Å)/LiF(10 Å)/Al(1000 Å)

### Synthesis of Compound I

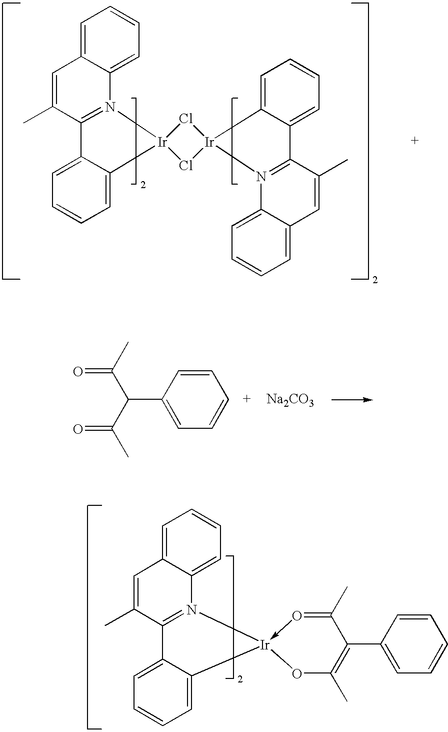

The chloro-bridged iridium dimer of 3-methyl-2-phenylquinoline was synthesized according to U.S. Pat. No. 6,835,469. The chloro-bridged iridium dimer of 3-methyl-2-phenylquinoline (3.0 g, 2.26 mmol), 3-phenyl-2,4-pentanedione (1.19 g, 6.75 mmol), sodium carbonate (2.39 g, 22.6 mmol), and 2-ethoxyethanol (30 ml) were refluxed in a 125 ml, three-necked flask. The reaction was followed by thin layer chromatography (triethylamine treated). The reaction was complete after one hour. The mixture was cooled, filtered, and the precipitated product was washed with methanol and hexanes. The crude solid was dissolved in dichloromethane, and filtered through a small silica plug to remove insoluble materials. Removal of the solvent under reduced pressure provided 3.31 g of red crystals in a 94.6 percent yield, which was further purified by vacuum sublimation.

### Synthesis of Compound II

Step 1: Synthesis of 2-(4-biphenyl)quinoline

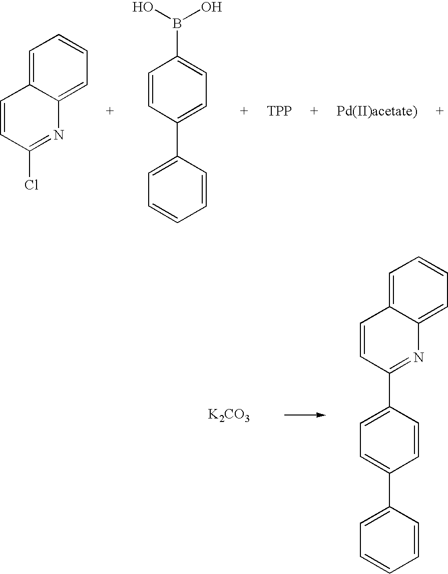

2-Chloroquinoline (9.0 g, 55.0 mmol), 4-biphenyl boronic acid (13.0 g, 65.7 mmol), triphenylphosphine (1.44 g, 5.5 mmol), palladium(II) acetate (0.37 g, 1.6 mmol), potassium carbonate (20.5 g, 148 mmol), dimethoxyethane (80 ml), and water (72 ml) were mixed, purged for 20 minutes with nitrogen, and then refluxed overnight. The reaction mixture was cooled, filtered through celite, and washed with ethyl acetate. The top layer of the celite/precipitate mixture was slurried in methylene chloride, and filtered to remove insoluble materials. The solvent was removed under reduced pressure to provide 7.66 g of the product as a fluffy solid, having an HPLC purity of 99.3 percent. The remaining celite mixture was slurried in methylene chloride, filtered, and the solvent removed under reduced pressure to provide a second crop of 7.0 g of the product for a total yield of 94.6 percent.

Step 2: Synthesis of 2-(4-biphenyl)quinoline Chloro-bridged Iridium Dimer

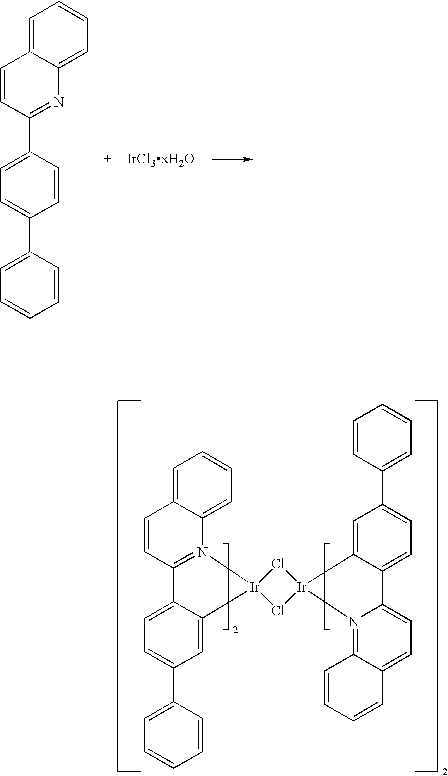

2-(4-biphenyl)quinoline (7.66 g, 27.2 mmol), iridium(II) chloride hydrate (4.85 g, 13.6 mmol), 2-ethoxyethanol (190 ml) and water (30 ml) were heated to reflux overnight in a 500 ml, three-necked flask. The reaction mixture was cooled, the solvent removed under reduced pressure, and the resultant slurry was returned to the original reaction vessel using 200 ml of 2-ethoxyethanol. The mixture was again heated to reflux overnight. A filtered and washed sample from the mixture showed no ligand by HPLC. The flask was cooled, and the slurry filtered and washed with 2-ethoxyethanol and hexanes to provide 9.51 g of the dimer at an 88.6 percent yield.

Step 3: Synthesis of bis[2-(4-biphenyl)quinoline]iridium(3-phenylacac)

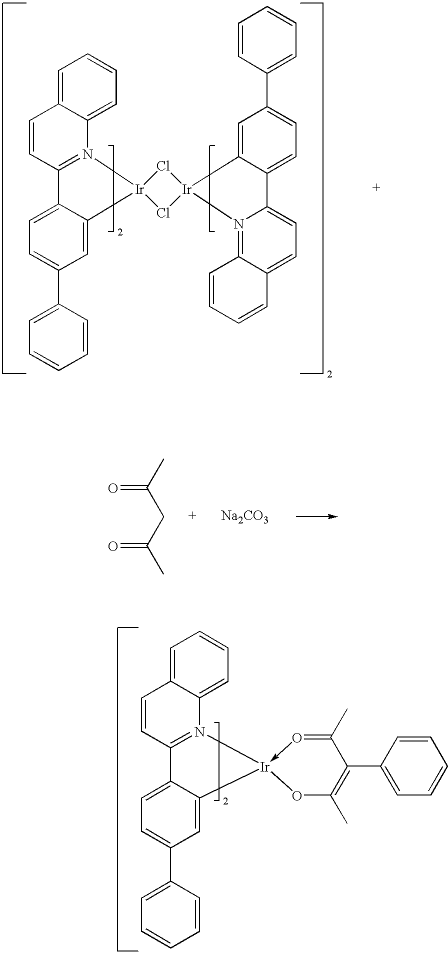

The chloro-bridged iridium dimer of 2-(4-biphenyl)quinoline (3.0 g, 1.9 mmol), 3-phenyl-2,4-pentanedione (1.0 g, 5.7 mmol), sodium carbonate (2.0 g, 19.0 mmol), and 2-ethoxyethanol (45 ml) were refluxed in a 125 ml, three-necked flask. The reaction was followed by thin layer chromatography (triethylamine treated). The reaction was complete after one hour. The mixture was cooled, filtered, and the precipitated product was washed with methanol and hexanes. The crude solid was dissolved in dichloromethane and filtered through a small silica plug to remove insoluble materials. Removal of the solvent under reduced pressure provided 3.2 g of the product as red crystals. The solid was recrystallized from dichloromethane (55 ml) to provide 2.97 g of the product in an 84.1 percent yield, which was further purified by vacuum sublimation.

Devices utilizing Compound I of the invention have a high device efficiency (9 to 11 cd/A and 9 to 12 percent EQE at 500 cd/m²) and high device operation stability, when compared to devices of the Comparative Examples. Devices utilizing Compound II of the invention have an even higher device efficiency (16 to 20 cd/A and 12 to 14 percent EQE at 500 cd/m²). The operation stability of the Compound II devices is slightly less than the Comparative Device Examples, but, nonetheless, still have a high stability. The results suggest that the 3-Phacac ligand is a highly useful ligand in phosphorescent metal complexes.

The 3-Phacac ligand can be easily modified by straightforward organic synthesis to tune properties such as solubility, evaporation temperature, electrochemistry (oxidation, reduction, and reversibility), steric bulkiness, etc. The ability to modulate these properties is important to achieve the best device performance, stability, and manufacturability.

Compounds I and II are soluble in common organic solvents (e.g., >0.01 g in 10 ml of toluene), and can be applied by solution deposition methods such as spin-coating and inkjet printing in device fabrication.

TABLE 1
Material and Device Summary

| | | | | | | | | | T80%(h) | |
|---|---|---|---|---|---|---|---|---|---|---|
| | | | | | DOP | | EQE | | at RT | Lo, at 40 mA/cm2, |
| | EX | DOP | DS | HIL | (%) | LE | (%) | CIE | J = 40 mA/cm2 | nits |
| invention | 1 | Compound I | R3 | Ir(3- | 6 | 11.0 | 11.1 | 0.66 | 765 | 3,270 |
| | | | | Meppy)₃ | | | | 0.34 | | |
| | 2 | Compound I | R3 | Ir(3- | 12 | 11.2 | 12.1 | 0.66 | 1060 | 3,840 |
| | | | | Meppy)₃ | | | | 0.34 | | |
| | 3 | Compound I | R3 | CuPc | 6 | 11.4 | 11.1 | 0.65 | 690 | 3,400 |
| | | | | | | | | 0.34 | | |
| | 4 | Compound I | R3 | CuPc | 12 | 8.9 | 9.2 | 0.66 | 1000 | 2,930 |
| | | | | | | | | 0.34 | | |
| invention | 5 | Compound II | R3 | Ir(3- | 6 | 16.3 | 12.2 | 0.64 | 519 | 4,850 |
| | | | | Meppy)₃ | | | | 0.36 | | |
| | 6 | Compound II | R3 | Ir(3- | 12 | 17.6 | 13.6 | 0.64 | 434 | 5,500 |
| | | | | Meppy)₃ | | | | 0.35 | | |
| | 7 | Compound II | R3 | CuPc | 6 | 19.9 | 14.4 | 0.64 | 410 | 5,700 |
| | | | | | | | | 0.36 | | |
| | 8 | Compound II | R3 | CuPc | 12 | 16.4 | 12.3 | 0.64 | 410 | 4,900 |
| | | | | | | | | 0.36 | | |
| comparative | 1 | Ir(3- | R3 | CuPc | 6 | 16.4 | 14.4 | 0.64 | 428 | 4,660 |
| | | Mepq)₂(acac) | | | | | | 0.35 | | |
| | 2 | Ir(3- | R3 | CuPc | 12 | 14.5 | 13.5 | 0.65 | 540 | 4,414 |
| | | Mepq)₂(acac) | | | | | | 0.35 | | |
| | 3 | Ir(3- | R3 | Ir(3- | 12 | 15.2 | 14.9 | 0.65 | 1000 | 4,800 |
| | | Mepq)₂(acac) | | Meppy)₃ | | | | 0.65 | | |

DOP: Dopant
DS: Device Structure
EQE: External Quantum Efficiency
EX: Device Example
LE: Luminous Efficiency (cd/A) at 500 cd/m2

1. A compound of the formula (I): 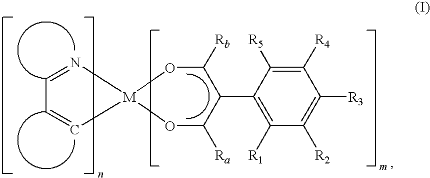
where M is a heavy metal, having an atomic weight greater than 40, Rₐ, R_{b}, and R₁ to R₅ are independently H, alkyl, alkenyl, alkynyl, aryl, arylalkyl, heteroaryl and heteroarylalkyl, m is 1 to 3, and n is 0 to 2.

2. The compound of claim 1, wherein M is iridium(III).

3. The compound of claim 1, wherein M is platinum(II).
